(19) United States
(12) Patent Application Publication
(10) Pub. No.: US 2007/0230532 A1
(43) Pub. Date: Oct. 4, 2007

(54) Display laser light source

(76) Inventors: Nigel Copner, Gwent (GB); Rance Fortenberry, Cazadero, CA (US); Mike Scobey, Santa Rosa, CA (US)

Correspondence Address: THE LAW OFFICE OF STEVEN G ROEDER, 5560 CHELSEA AVE, LA JOLLA, CA, 92037, US

(21) Appl. No.: 11/732,693

(22) Filed: Apr. 3, 2007

Related U.S. Application Data
(60) Provisional application No. 60/789,321, filed on Apr. 4, 2006.

(51) Int. Cl. H01S 3/10; H01S 3/08

(52) U.S. Cl. 372/92; 372/100; 372/21

(57) ABSTRACT

A display light source (230) includes a gain media (232), an output reflector (246), and a wavelength converter (244) that cooperate to generate a source output beam (260). The gain media (232) generates a media output beam (247) that exits an output facet (232B) of the gain media (232). The media output beam (247) has a first spectral frequency range and a relatively large number of modes. The output reflector (246) is spaced apart from the gain media (232), and the output reflector (246) forms a portion of a laser cavity (251). The wavelength converter (244) is positioned within the laser cavity (251). The wavelength converter (244) converts at least a portion of the media output beam (247) from the first spectral frequency range to a converted beam (258) having at a secondary spectral frequency range. For example, the wavelength converter (244) can double the frequency of the media output beam (247). Additionally, the light source (230) can include a wavelength controller (238) that controls the number of modes that are lasing in the laser cavity (251), and that controls the spectral width and the center wavelength of the light that is lasing in the laser cavity (251)

### REFERENCE TO RELATED APPLICATION

This Application claims the benefit on U.S. Provisional Application Ser. No. 60/789,321 filed on Apr. 4, 2006. The contents of U.S. Provisional Application Ser. No. 60/789,321 are incorporated herein by reference.

### BACKGROUND

Light sources provide light for projection systems and other optical equipment. A typical projection display uses a UHP arc lamp as the light source. Unfortunately, the arc lamp has a relatively large etendue, is unpolarised, emits over a broad spectrum (but low in red content), has a relatively short lifetime and requires a ballast., Unfortunately, even the most optimized projection system has an optical throughput of less than 10 percent of the original arc lamp light output.

Recently, light emitting diodes (“LEDs”) are being looked at as a replacement for the arc lamp. Unfortunately, the etendue of LEDs is still undesirably high and the use of only a few LEDs per color quickly exceeds the etendue of the projection engine thereby impacting optical throughput.

### SUMMARY

A light source for a display includes a gain media, an output reflector, and a wavelength converter that cooperate to generate a source output beam. The gain media generates a media output beam that exits an output facet of the gain media. The media output beam has a first spectral frequency range and a relatively large number of modes. The output reflector is spaced apart from the gain media, and the output reflector forms a portion of a laser cavity. The wavelength converter is positioned within the laser cavity. The wavelength converter converts at least a portion of the media output beam from the first spectral frequency range to a converted beam having a secondary spectral frequency range.

With this design, in certain embodiments, the light source can efficiently generate the source output beam in the visible light range. For example, the light source will consume relatively low power, i.e. approximately 0.5 to 1 watt per color. This reduces the amount of heat generated by the light source. Additionally, the light source has a relatively long operational lifespan, has good power stability, and is relatively small in size. Furthermore, with the present light source, the source output beam has relatively low speckle, is highly polarized, and has a relatively low etendue.

Additionally, the light source can include a wavelength controller, e.g. a thin-film filter, positioned in the laser cavity that limits the number of modes that are lasing in the laser cavity. For example, the wavelength controller can limit the number of modes that are lasing in the laser cavity to between approximately 10 and 100 modes. Moreover, the wavelength controller can control the center wavelength that is lasing in the laser cavity. As discussed in more detail below, the wavelength controller improves the efficiency of the system and the quality of the source output beam.

In one embodiment, the wavelength controller is positioned between the gain media and the wavelength converter. Alternatively, the wavelength controller can be positioned between the wavelength converter and the output reflector.

In one embodiment, the output reflector reflects light in the infrared range and transmits frequencies of light above the infrared range. Alternatively, in other designs, the output reflector reflects light in the infrared range and reflects light above the infrared range.

In certain embodiments, the light source also includes an intermediate reflector positioned between the gain media and the wavelength converter. In this embodiment, a portion of the media output beam is directed through the intermediate reflector into the wavelength converter and converted into the converted beam. Further, a portion of the converted beam is transmitted through the output reflector as the source output beam. Additionally, a portion of the converted beam is reflected off of the output reflector as a reflected converted beam. Moreover, the reflected converted beam is directed into the wavelength converter and a portion of the reflected converted beam is transmitted through the intermediate reflector to the gain media. Additionally, a portion of the reflected converted beam is reflected off of the intermediate reflector back to the wavelength converter.

Additionally, the present invention is directed to a method for generating a source output beam. In one embodiment, the method includes the steps of: (i) generating a media output beam with a gain media, the media output beam having a first spectral range and a relatively large number of modes; (ii) reflecting light with an output reflector that is spaced apart from the gain media, the output reflector forming a portion of a laser cavity; and (iii) converting at least a portion of the media output beam from the first spectral range to a converted beam having at a secondary spectral range with a wavelength converter that is positioned within the laser cavity.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified perspective illustration of a precision apparatus having features of the present invention;

FIG. 2A is a simplified side illustration of a light source having features of the present invention;

FIG. 2B is a simplified illustration of a wavelength controller having features of the present invention; and

FIGS. 3-8 illustrate alternative embodiments of light sources having features of the present invention.

### DESCRIPTION

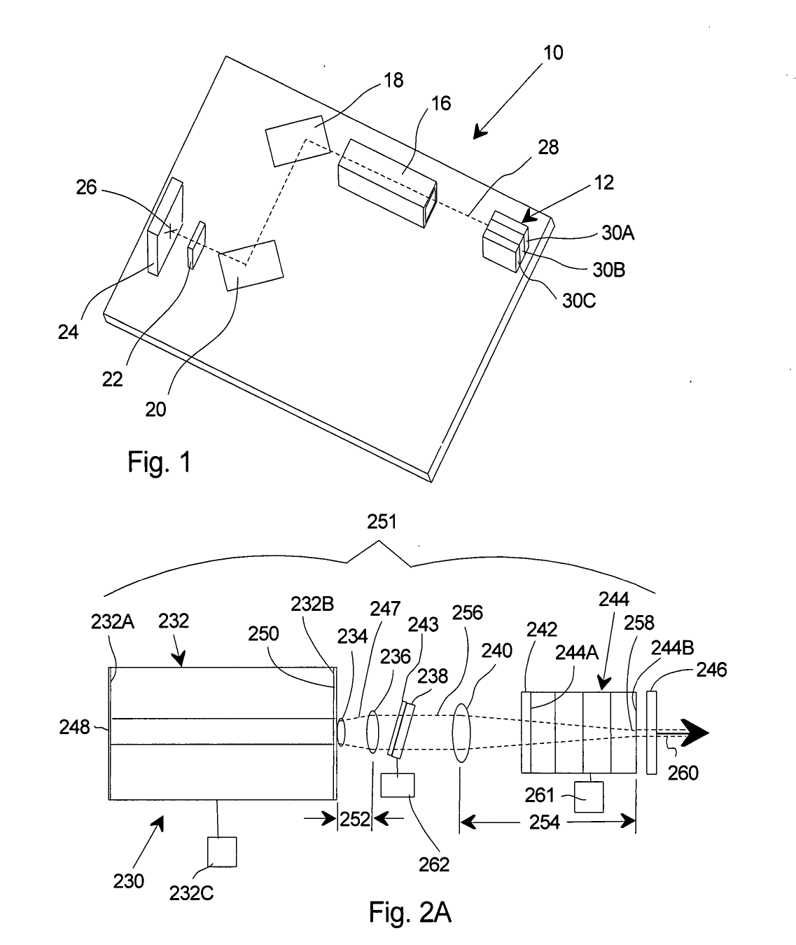

Referring initially to FIG. 1, the present invention is directed to a precision apparatus 10 that, for example, can be used as or in optical communications, light projection systems, scientific instruments and manufacturing equipment. FIG. 1 is a simplified, non-exclusive, perspective view of one embodiment of the precision apparatus 10. In this embodiment, the precision apparatus 10 is a light projection system, commonly referred to a Digital Mirror Device (“DMD system”). Alternatively, for example, the precision apparatus 10 can be another type of projection system such as a Liquid Crystal Display (LCD) system or a Liquid Crystal on Silicon (LCOS) system.

In FIG. 1, the precision apparatus 10 includes a light source assembly 12, a beam homogenizer 16, a mirror 18, an imager 20, a lens 22, and a screen 24 that cooperate to generate an image 26 (represented as an “X”) on the screen 24. The design and orientation of the components of the precision apparatus 10 can be changed to suit the requirements of the precision apparatus 10. Further, the precision apparatus 10 can be designed with fewer or more components than those illustrated in FIG. 1.

The light source assembly 12 generates light for the projection system 10. As an overview, in certain embodiments, the light source assembly 12 generates a light beam 28 that includes blue light, green light and red light. As a result thereof, one or more components, such as a color wheel is not required for the DLP system. Alternatively, the light source assembly 12 could be designed to generate more than three or fewer than three colors.

Moreover, in certain embodiments, the light source assembly 12 can be designed to efficiently generate a focused light beam 28 with relatively low power, i.e. approximately 0.5 to 1 watt per color. This reduces the amount of heat generated by the light source assembly 12 and improves the performance of the precision apparatus 10. Additionally, the light source assembly 12 has a relatively long operational lifespan, has good power stability, and is relatively small in size. Furthermore, with the present light source assembly 12, the light beam 28 has relatively low speckle, is highly polarized, and has a relatively low etendue.

In one embodiment, the light source assembly 12 includes three separate light sources, namely a blue light source 30A (illustrated as a box) that generates the blue light beam, a green light source 30B (illustrated as a box) that generates the green light beam, and a red light source 30C (illustrated as a box) that generates the red light beam. Alternatively, the light source assembly 12 could be designed to have more than three or fewer than three light sources.

The beam homogenizer 16 homogenizes the light 28 that is exiting the light source assembly 12. In FIG. 1, the beam homogenizer 16 is a light pipe. In certain embodiments, the beam homogenizer 16 may not be necessary because the beam 28 is such high quality that the beam 28 can be directly transferred to the imager 20.

The mirror 18 reflects the light 28 exiting from the beam homogenizer 16 and directs the light 28 at the imager 20.

The imager 20 creates the image 26. In one embodiment, the imager 20 is a digital light processing chip that includes anywhere from approximately 800 to more than 1 million tiny mirrors that are individually controlled to generate the image 20. Alternatively, for example, the imager 20 can be a LCD imager or a LCOS imager.

The lens 22 collects the image 26 from the imager 20 and focuses the image 26 on the screen 24. The screen 24 displays the image 26.

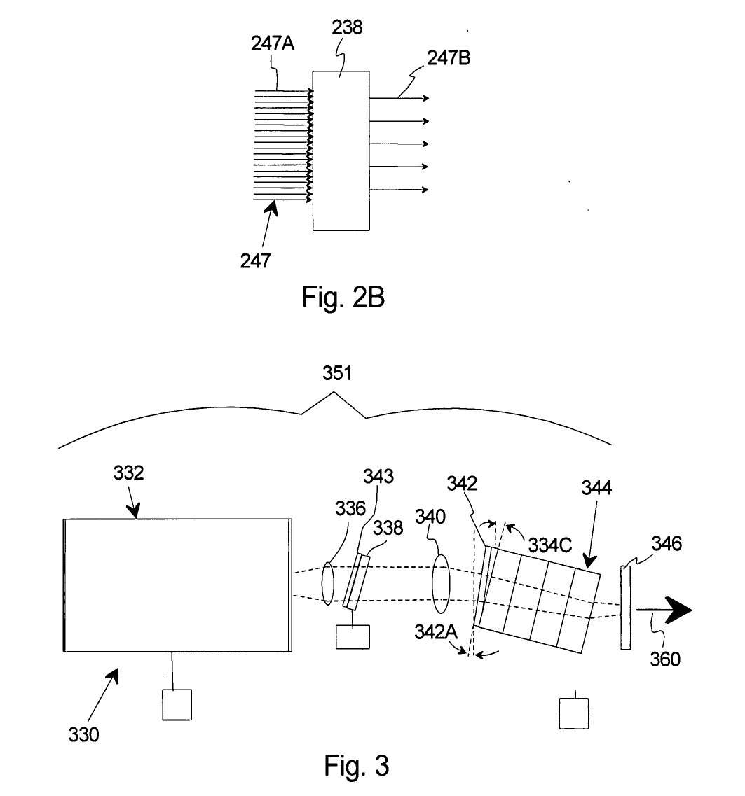

FIG. 2A is a simplified side illustration of one embodiment of a light source 230 that can be configured as the blue light source 30A, the green light source 30B, the red light source 30C of FIG. 1, or another color light source. In this embodiment, the light source 230 includes a gain media 232, a first optical assembly 234, a second optical assembly 236, a wavelength controller 238 (e.g. an optical filter), a third optical assembly 240, an intermediate reflector 242, a wavelength converter 244, and an output reflector 246. Alternatively, the light source 230 can be designed with fewer components or more components than those illustrated in FIG. 2. For example, the first and second optical assemblies 234, 236 can be combined.

It should be noted that with the designs disclosed herein, with relatively small changes in the specifications of the components, the light source 230 can be alternatively designed to be (i) a blue light source 30A that generates blue light, (ii) a green light source 30B that generates green light, or (iii) a red light source 30C that generates red light. Alternatively, the light source 230 could be designed to create other colors such as yellow, cyan, or magenta, for example.

The gain media 232 generates the light for the light source 230. In one embodiment, the gain media 232 is a semiconductor laser such as a laser diode bar that contains a plurality of emitters. In alternative, non-exclusive embodiments, the laser diode bar can include an array of 5, 10, 15, 20, or 50 emitters. In one embodiment, the gain media 232 emits a multiple frequency, media output beam 247 to reduce speckle. In certain embodiments, the media output beam 247 has numerous longitudinal modes, typically in the thousands.

In certain embodiments, the laser diode bar is reliable, stable, and has a relatively long lifetime. A suitable diode bar can be made of InGaAs/AlGaAs. A suitable laser diode bar can be purchased from Bookham, located in Zurich Switzerland.

In one embodiment, the gain media 232 includes a reflector facet 232A that is coated with a high reflection (“HR”) coating 248 and an output facet 232B that is coated with an anti-reflection (“AR”) coating 250. The HR coating 248 reflects light that is directed at the reflector facet 232A back into the gain media 232. In alternative, non-exclusive embodiments, the HR coating 248 has a reflectivity of greater than approximately 90, 95, or 99 percent. With this design, the reflector facet 232A cooperates with the output reflector 246 to define a laser cavity 251.

The AR coating 250 allows light to exit the gain media 232 and allows light that has rebounded from the output reflector 246 and passed through the intermediate reflector 242 to easily enter the gain media 232. In alternative, non-exclusive embodiments, the AR coating 250 has an average reflectivity of less than approximately 1, 0.1, or 0.01 percent. In certain embodiments, the gain media 232 requires alignment with the output reflector 246 so that light can be rebounded back into the gain media 232.

In certain embodiments, one or both of the facets 232A, 232B can be angled to enhance performance of the light source 230.

In one non-exclusive embodiment, (i) to ultimately generate a blue light, the gain media 232 is designed to emit a media output beam 247 having an average wavelength of approximately 940 nm; (ii) to ultimately generate a green light, the gain media 232 is designed to emit a media output beam 247 having an average wavelength of approximately 1050 nm; and (iii) to ultimately generate a red light, the gain media 232 is designed to emit a media output beam 247 having an average wavelength of approximately 1240 nm.

It should be noted that the media output beam 247 has a first spectral range. For example, (i) to ultimately generate a blue light, the first spectral wavelength range of the media output beam 247 can be between approximately 800 and 1000 nm; (ii) to ultimately generate a green light, the first spectral wavelength range of the media output beam 247 can be between approximately 1000 and 1100 nm; and (iii) to ultimately generate a red light, the first spectral wavelength range of the media output beam 247 can be between approximately 1200 and 1400 nm.

In certain embodiments, the exact temperature of the gain media 232 is not critical for wavelength control. In these embodiments, active temperature control of the gain media 232 is not necessary. Alternatively, the temperature of the gain media 232 can be actively controlled with a media controller 232C that can include a heat pipe, water or air, for example.

Further, in certain embodiments, the gain media 232 can be modulated in time at or near a resonant frequency of the cavity to enhance conversion by the wavelength converter 244.

The first optical assembly 234 improves the shape of the media output beam 247 exiting the output facet 232B of the gain media 232. For example, the first optical assembly 234 can eliminate both astigmatism/beam waist asymmetry to maximize the conversion efficiencies and cavity stability. In one embodiment, the first optical assembly 234 includes an anamorphic lens or an array of lenses in the case of a multi-stripe gain media 232. For example, the first optical assembly 234 can be spaced apart from the gain media 232 approximately 0.1 mm.

The second optical assembly 236 collimates and focuses the media output beam 247 on the wavelength controller 238. For example, the second optical assembly 236 can include one or more optical lens. It should be noted that the second optical assembly 236 is positioned a SOE focal length 252 from the output facet 232B of the gain media 232. Further, the beam waist of the media output beam 247 can be changed by changing the SOE focal length 252. In one non-exclusive embodiment, the SOE length can be approximately 1.5 mm.

In another embodiment, the first optical assembly 234 and the second optical assembly 236 can be combined into a single optical element by using an aspherical lens or series of lenses.

The wavelength controller 238 reduces and limits the number of longitudinal modes that are lasing in the laser cavity 251. Further, the wavelength controller 238 can reduce the spectral width of the light that is directed to the wavelength converter 244 and can control the center wavelength of the light. In this embodiment, the wavelength controller 238 is used to precisely control the number of longitudinal modes, the wavelength, and the spectral width of the light that is lasing in the laser cavity 251. Stated in another fashion, the media output beam 247 that passes through the wavelength controller 238 has a center wavelength and spectral width defined by the wavelength controller 238.

In alternative, non-exclusive embodiments, the wavelength controller 238 reduces the number of longitudinal modes that are lasing in the laser cavity 251 to less than approximately 100, 90, 80, 70, 60, 50, 40, 30, 20, or 10 longitudinal modes.

Stated in another fashion, in alternative, non-exclusive embodiments, the wavelength controller 238 reduces the number of longitudinal modes that are lasing in the laser cavity 251 to between approximately 10-100 longitudinal modes, 30-70 longitudinal modes, or 40-60 longitudinal modes.

FIG. 2B is a simplified illustration of the wavelength controller 238. In this illustration, arrows 247A represent the relatively large number of longitudinal modes in the media output beam 247 prior to the wavelength controller 238 and arrows 247B represent the reduced number of longitudinal modes.

Additionally, in alternative, non-exclusive embodiments, the wavelength controller 238 reduces the spectral width to less than approximately 5, 1, 0.5, 0.4, 0.3, 0.2, or 0.1 nanometers. In one embodiment, the wavelength controller 238 reduces the number of modes to approximately 60. This number assumes an effective spectral width for the wavelength controller 238 of approximately 0.3 nanometers and a cavity length that gives a mode spacing of approximately 0.05 nanometers.

Referring back to FIG. 2A, in certain embodiments, the efficiency of the wavelength converter 244 can be adversely influenced if there is an excessive number of longitudinal modes. However, if the number of longitudinal modes is too low, the light source 230 is likely to mode hop and have fluctuations in amplitude. The present invention balances these factors by using a relatively small number (in certain embodiments between approximately 10-100) of longitudinal modes to reduce speckle and mode hop sensitivity. Further, because the light that passes through the wavelength controller 238 has a relatively small spectral width, the efficiency of the wavelength converter 244 is better than prior art designs.

Further, as discussed above, the wavelength controller 238 can be used to control the center wavelength of the light that is directed at wavelength converter 244. With this design, the wavelength controller 238 can be designed to control the average wavelength to be at or near optimum/designed wavelength for conversion by the wavelength converter 244. Stated in another fashion, the wavelength controller 238 forces the laser cavity 251 to lase at or near the optimum wavelengths for conversion with the wavelength converter 244. As a result thereof, the wavelength converter 244 can efficiently convert the light. Thus, the multimode output when used with the wavelength controller 238 enhances conversion efficiency, reduces speckle and eliminates mode hop sensitivity.

In one embodiment, the wavelength controller 238 is an optical filter that transmits or blocks a portion of the spectrum of the media output beam 247 that is directed at the wavelength controller 238. The portion of the media output beam 247 that passes through the wavelength controller 238 is referred to herein as the transmitted beam 256. The transmitted beam 256 is subsequently directed to the wavelength converter 244.

In one embodiment, the optical filter 238 is a band pass type filter that transmits a band of wavelengths (“the passband”) and blocks wavelengths outside of the passband. The passband has a center wavelength that is at the center of the passband. For example, in alternative non-exclusive embodiments, the filter is a narrow band pass filter with a passband having a bandwidth of less than approximately 0.1, 0.2, 0.3, 0.4, 0.5, 1, or 5 nanometers. As a result thereof, the transmitted beam 256 has a relatively narrow spectral width compared to the spectral width of the media output beam 247.

Further, the transition from transmitting to rejection can be sharp. In alternative, non-exclusive embodiments, the optical filter has a spectral slope capable of transitioning between 10% and 90% transmission in less than 0.2 nm, 0.5 nm, 1 nm, or 5 nm.

In certain embodiments, the optical filter 238 is designed so that the center wavelength of the passband is near the optimum/designed wavelength for conversion by the wavelength converter 244. As a result thereof, the wavelength converter 244 can efficiently convert the transmitted beam 256. The optical filter 238 can be rotated to align the center wavelength to the wavelength converter 244.

With this design, the optical filter 238 controls the transmitted beam 256 to match the wavelength of acceptance of the wavelength converter 244. Further, in certain embodiments, the transmitted beam 256 is passively controlled by the optical filter 238. As a result thereof, the wavelength and temperature control issues of the gain media 232 are reduced or eliminated.

Additionally, the shape of the optical filter 238 can be adjusted to improve the performance of the light source 230. Simple filters such as single cavity thin film filters have a roughly Gaussian peak which gives a certain performance. In certain embodiments, multiple cavity filters can be used to make the shape flat or arbitrarily shaped in such a way as to enhance the performance of the light source 230. In addition, the bandwidth of the filter can be optimized to improve such laser parameter performance such as speckle reduction. In one embodiment, the optical filter 238 is a bat ear filter having a relatively flat center with peaks at each edge. With the present invention, the shape and characteristics of filters can be changed to improve the performance of the light source 230, such as operation on a selected combination of wavelength modes to improve speckle.

In certain embodiments, the optical filter 238 can be rotated to align to the wavelength converter 244. Additionally, the filter 238 can be designed to be temperature sensitive in the same direction as the wavelength converter 244 so that the center wavelength changes in the same fashion as the wavelength of acceptance of the wavelength converter 244 as temperature changes.

Additionally, the light source 230 can include a wavelength adjuster 262 (any mechanism) that adjusts the wavelength controller 238. For example, the wavelength adjuster 262 can adjust the angle of the filter 238 with temperature (or adjusts the filter via heat or stress or some other way) to achieve the desired center wavelength to maintain optimum conversion efficiency of the wavelength converter 244. The wavelength adjuster 262 can tilt the filter 238, rotate the filter 238, adjust the temperature (heat and/or cool) of the filter 238, add or release stress to the filter 238, and/or add or remove an electric field to the filter 238 to accurately control and adjust the center wavelength of the filter 238.

A suitable optical filter 238 can be purchased from Bookham, located in Santa Rosa, Calif.

The third optical assembly 240 focuses the light beam 228 on the wavelength converter 244. For example, the third optical assembly 240 can include one or more optical lens. It should be noted that the third optical assembly 240 is positioned a TOE focal length 254 from a second side 244B of the wavelength converter 244. Further, the beam waist of the light beam 258 at the second side 244B and exiting the light source 230 can changed by changing the TOE focal length 254. For example, as the TOE focal length 254 is increased, the beam waist is decreased. In one non-exclusive embodiment, the TOE focal length 254 is approximately 13 mm.

In FIG. 2A, the intermediate reflector 242 transmits wavelengths of the reflected beam that are in the IR range and reflects wavelengths of the reflected beam that are in the visible range. In this embodiment, the intermediate reflector 242 transmits all of the transmitted beam 256 that has passed through the third optical assembly 240, transmits the portion of the reflected beam that is in the infrared (IR) range and that has reflected off of the output reflector 246 and reflects the portion of the reflected beam that has been converted to visible light (e.g. having frequency in electromagnetic spectrum range above infrared) by the wavelength converter 244 after having reflected off of the output reflector 246. With this design, only light in the infrared range is being directed back to the gain media 232. This improves the efficiency of the light source 230 as all the visible light is directed out through the output reflector 246.

With the present design, in FIG. 2A, all of the light in the infra-red range is trapped between the output reflector 246 and the reflector facet 232A of the gain media 232 (they form the laser cavity 251), and the intermediate reflector 242 is used only to reflect the doubled, visible light from going back into the gain media 232 and being absorbed. Instead, the visible light ends up being reflected back through the output reflector 246 which has high transmission in the visible and high reflection in the IR range as detailed below.

The intermediate reflector 242 can be tilted to allow the visible beam to come out of the laser at an angle. This is particularly useful in other embodiments where the output reflector 246 is designed to reflect both IR and visible light because then all of the light comes out after bouncing off of the intermediate reflector 242. This is shown more clearly in FIG. 7 and discussed in more detail below.

Referring back to FIG. 2A, in some embodiments, a phase plate 243 can be positioned in the laser cavity 251 between the gain media 232 and the wavelength converter 244. This can be used to change the polarization of the IR light to optimize the conversion efficiency of the wavelength converter 244. The phase plate 243 could be, but is not limited to, a half-wave plate or quarter-wave plate. In FIG. 2A, the phase plate 243 is positioned in front of the wavelength controller 238. Alternatively, the phase plate 243 can be in another location. In other embodiments, a phase plate can be positioned after the wavelength converter 244 and before the output reflector 246. It should be noted that the use of a phase plate is optional depending on the properties of the particular wavelength converter 244 being used. For example, single crystal wavelength converters may or may not need a phase plate depending on the orientation of the crystal axes relative to the polarization of the media output beam.

The wavelength converter 244 changes the wavelength of the transmitted beam 256 and any reflected beam that was reflected off of the output reflector 246. In each of the embodiments illustrated herein, the wavelength converter 244 is located in the laser cavity 251. As a result of the intra-cavity conversion, the enhanced energy in the laser cavity 251 improves the performance of the light source 230. Further, a shorter wavelength converter 244 can be used because of the improved efficiency of intra-cavity conversion. In FIG. 2A, the wavelength converter 244 is located between the intermediate reflector 242 and the output reflector 246.

In one embodiment, the wavelength converter 244 is a highly nonlinear/robust crystal such as MgO doped periodically poled lithium niobate (PPLN). The PPLN has good long term stability and is very robust with a very high optical intensity damage threshold.

The wavelength converter 244 can function as a second harmonic generation crystal that efficiently doubles the frequency of the transmitted beam 256. In this embodiment, the transmitted beam 256 is converted into a converted beam 258 by the wavelength converter 244 and the converted beam 258 has a wavelength that is one half of the wavelength of the transmitted beam 256; and the converted beam 258 has a frequency that is twice the frequency of the transmitted beam 256.

In this embodiment, the media output beam 247 has a first spectral frequency range while the converted beam 258 is in a secondary spectral frequency range that is approximately twice the first spectral frequency range. Thus, the wavelength converter 244 is an intra-cavity frequency doubler.

In FIG. 2, the wavelength converter 244 includes a first side 244A and a second side 244B. One or both of the sides 244A, 244B can be angled to enhance the performance of the light source 230.

In certain embodiments, the angular sensitivity of the PPLN is such that the FWHM is 2 degrees. Further, the FWHM of the wavelength range for efficient conversion for a 10 millimeter long PPLN can be approximately 0.4 nanometer. Thus, a PPLN of approximately 10 millimeters can be used. The relatively short length of PPLN is enabled by the intra-cavity approach disclosed herein. This reduces the cost and size.

In one embodiment, the temperature of the wavelength converter 244 is actively controlled with a converter temperature controller 261. The converter temperature controller 261 can include heater or cooler. Because the wavelength controller 238 forces the laser operation over multiple modes (approximately 60 in one example), the temperature stability of the wavelength converter 244 can be improved to approximately one degree Celsius. Accordingly, only crude temperature control of the wavelength converter 244 is necessary. This simplifies the design of the light source 230.

It should be noted that the wavelength of acceptance of the wavelength converter 244 can be controlled by controlling the temperature of the wavelength converter 244 with the converter temperature controller 261 to tune the light source 230.

In one embodiment, the temperature of the wavelength converter 244 is tied to the location of the center wavelength as controlled by the wavelength controller 238. For example, as discussed above the wavelength adjuster 262 can be used to adjust the wavelength controller 238 to maintain optimum conversion efficiency.

The wavelength converter 244 has an optimum conversion wavelength that varies, roughly linearly, with temperature. Any simple mechanism, such as a piece of material attached to one edge of the filter 238 which causes it to tilt slightly about its center as the material expands and contracts with temperature, could cause the filter center wavelength to adjust and match the change in the wavelength converter 244 for optimum conversion wavelength. Another novel approach is to have the optical filter 238 on a substrate such that a change in temperature causes a change in stress and/or cavity thickness which causes the optical filter 238 to tune its wavelength with temperature to match that of the wavelength converter 244. In principle, these give totally passive ways to keep conversion efficiency high without any need for active control of the temperature of the wavelength converter 244.

In certain embodiments, the operating wavelength of the wavelength converter 244 can also be adjusted by tilt, rotation, adjustment of the temperature, the addition or release of stress, and/or the application of an electric (or magnetic) field to the wavelength converter 244 to optimize performance.

The output reflector 246 reflects at least a portion of the light that travels through the wavelength converter 244 and cooperates with the HR coating 248 to form the laser cavity 251. One beam waist in the laser cavity is formed by the TOE 240 and is positioned at or near the surface of the output reflector 246. Thus, the laser cavity 251 is formed by means of a retro-reflection off of the output reflector 246. This position of the beam waist at the output reflector reduces the sensitivity of the light source 230 to any positioning errors and movement (such as due to vibration) of the laser cavity components. The output reflector 246 can also be referred to as an output coupler.

In FIG. 2A, the output reflector 246 transmits light in the visible range (sometimes referred to as “second range”) and reflects light in the infrared range (sometimes referred to as “first range”). More specifically, in FIG. 2A, the output reflector 246 (i) transmits the portion of the beam that has passed through the wavelength converter 244 and that has been converted to visible light, and (ii) reflects the portion of the beam that was not converted and that is in the infrared range back into the wavelength converter 244 so that the wavelength converter 244 can convert more of the unconverted beam, i.e. improve conversion efficiency. For example, the output reflector 246 can transmit wavelengths below 750 nanometers, and reflect wavelengths above 750 nanometers. In FIG. 2A, the light that is transmitted through the output reflector 246 is the light source output 260 of the light source 230 that can be directed to the beam homogenizer 16 (illustrated in FIG. 1). Thus, the light source output 260 is light in the visible range.

In an alternative, non-exclusive embodiment, the output reflector 246 reflects wavelengths of the converted beam 258 that are in the visible range as well as wavelengths of the converted beam 258 that are in the infrared range. An example of this is discussed below.

In alternative embodiments, the light source 230 is designed so that (i) the light source output 260 is a blue light, (ii) the light source output 260 is a green light, or (iii) the light source output 260 is a red light.

In FIG. 2A, the output reflector 246 is illustrated as being spaced apart from the second side of the 244B of the wavelength converter 244. This allows, for example, the freedom to allow the reflector 246 to be used to correct any variation in emitter placement across the gain media 232. For example, if the bar has multiple emitters whose exit facets are not in a perfectly straight line, a condition often called “smile”, the output reflector 246 can be either manufactured or adjusted while in place to have a corresponding curve to exactly balance the smile of the gain media 232. Alternately, a separate thickness spacer or lens or lens array can be inserted just before the output reflector 246 (or elsewhere in the cavity) to correct smile and other optical deviations. The extra freedom given by having output reflector 246 separate from other components can be used to correct many conditions such as smile, variations in emitter output direction of propagation, emitter heights, emitter polarization, etc.

In another embodiment, the output reflector 246 can be constructed of separate segments to allow the performance of each group of emitters in the bar to be optimized independently.

One improvement that could be placed before the output reflector 246 (or at any other beam waist in the cavity) is an aperture (not shown) which could act to keep the laser operating in a single transverse mode while allowing multiple axial modes to lase.

Alternatively, for example, the output reflector 246 can be positioned against the second side 244B of the wavelength converter 244, and the output reflector 246 could even be coated directly onto the wavelength converter 244 reducing the number of components that need to be mounted as well as reducing weight and size.

Additionally, in FIG. 2A, the beam waist is close to the second side 244B of the wavelength converter 244, near the output reflector 246 for optimal conversion. The beam waist near the output reflector 246 also facilitates retro-reflection off of the output reflector 246 and reduces the sensitivity of the light source 230 to any positioning errors and movement (such as due to vibration) of the laser cavity components.

Any long or short term variations in the gain media 232 can lead to mode hops or variations in the optical power of the particular longitudinal modes on which the laser cavity 251 is currently lasing. These can result in intensity fluctuations of the beam transmitted by the output coupler. Within the wavelength of acceptance of the wavelength converter 244, many longitudinal modes are excited such that the effects of a mode hop are eliminated. This feature allows the cavity length to change freely and reduces the temperature, vibration, shock stability criteria of the cavity, as well as providing highly beneficial increases in frequency doubling conversion efficiencies.

A brief summary of the light path is provided herein. In FIG. 2A, the media output beam 247 exits the output facet 232B of the gain media 232. Next, the media output beam 247 travels through the first optical assembly 234 and then the second optical assembly. Subsequently, the light is polarized with the phase plate 243 and the number of longitudinal modes (along with the spectral width and center wavelength) is adjusted with the wavelength controller 238. Next, the light passes through the third optical assembly 240 and the intermediate reflector 242. Subsequently, the light is directed into the wavelength converter 244 and at least a portion of the light is converted into the converted beam which is in the visible range.

Next, the light from the wavelength converter 244 is directed at the output reflector 246. In FIG. 2A, the output reflector 246 transmits the converted beam which is in the visible range (the source output beam 260) and reflects the portion of the light that was not converted (still in the infrared range) back into the wavelength converter 244 as a reflected non-converted beam. Subsequently, the reflected non-converted beam travels through the wavelength converter 244 to the intermediate reflector 242. In FIG. 2A, the intermediate reflector 242 transmits the portion of the light that is in the infrared range and reflects the portion of the light that is in the visible range back to the wavelength converter 244.

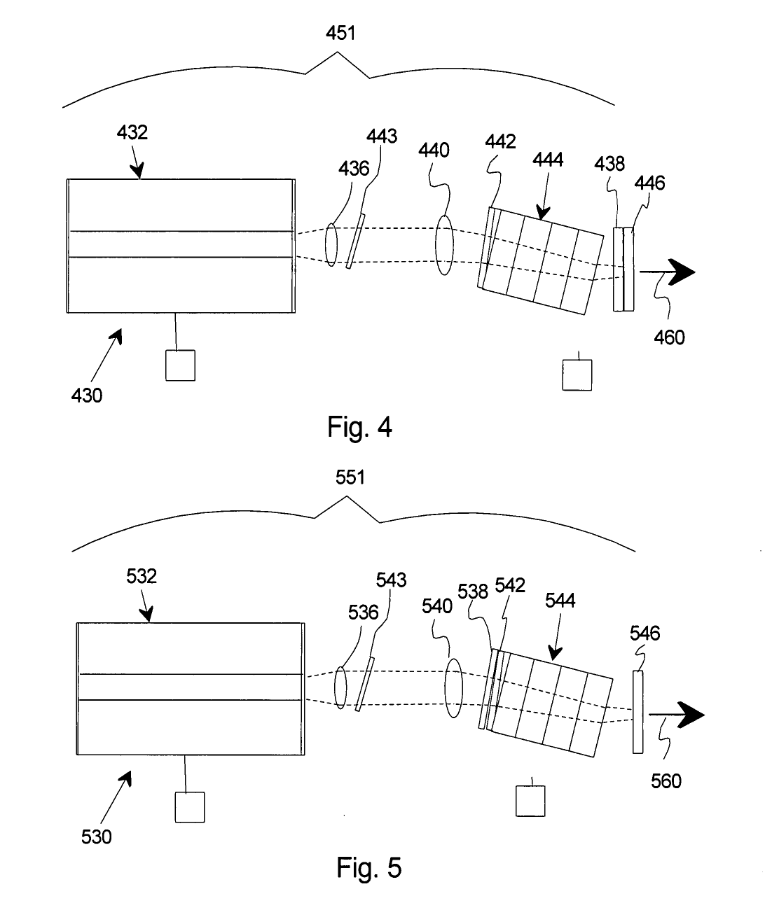

FIG. 3 illustrates another embodiment of a light source 330 that generates the output beam 360 that can be used in the apparatus 10 of FIG. 1. In this embodiment, the light source 330 includes a gain media 332, a wavelength controller 338, a third optical assembly 340, an intermediate reflector 342, a phase plate 343, a wavelength converter 344, and an output reflector 346 that are somewhat similar to the corresponding components described above and illustrated in FIG. 2A. However, in this embodiment, the intermediate reflector 342 is tilted to reduce interferometric interference (several arcmin). In one embodiment, the intermediate reflector 342 is coated directly onto the wavelength converter 344 surface to reduce the size, weight, cost and complexity of the light source 330.

Moreover, in FIG. 3, the wavelength converter 344 is also tilted (angled) so as to remove astigmatism and equalize beam waist in the wavelength converter 344. The amount of angle of the wavelength converter 344 can vary. It should be noted that the wavelength converter 344 can be tilted more or less than the tilt of the intermediate reflector 342.

Further, in FIG. 3, the light source 330 does not include the first optical assembly 234 (illustrated in FIG. 2) but has combined this optical element with the second optical assembly 336. Alternatively, these elements can be separate, similar to that illustrated in FIG. 2A.

In the embodiment illustrated in FIG. 3, the wavelength controller 338 still controls center wavelength and number of modes, the wavelength converter 344 is positioned in the laser cavity 351 and the beam waist of the third optical assembly 340 is still located at or near the output coupler 346.

FIG. 4 illustrates another embodiment of a light source 430 that generates an output beam 460 that can be used in the apparatus 10 of FIG. 1. In this embodiment, the light source 430 includes a second optical assembly 436, a gain media 432, a wavelength controller 438, a third optical assembly 440, an intermediate reflector 442, a phase plate 434, a wavelength converter 444, and an output reflector 446 that are somewhat similar to the corresponding components described above and illustrated in FIG. 3. However, in this embodiment, the wavelength controller 438 has been positioned between the wavelength converter 444 and the output reflector 446. Further, the wavelength controller 438 and the output reflector 446 can be coated simultaneously to reduce size, weight, cost, complexity, etc.

In the embodiment illustrated in FIG. 4, the wavelength controller 438 still controls center wavelength and number of modes, the wavelength converter 444 is positioned in the laser cavity 451 and the beam waist of the third optical assembly 440 is still located at or near the output coupler 446.

In FIG. 4, the wavelength controller 438 is illustrated as not being tilted. However, in certain types of reflection filters, the beam outside of the band pass of the filter can be reflected back into gain media 432 if the reflection filter is not tilted. Accordingly, with certain designs, the filter should be tilted. Alternatively, if the wavelength controller 438 is an absorption filter, it may not have to be tilted. These concerns can also apply to the embodiment illustrated in FIG. 6 described below.

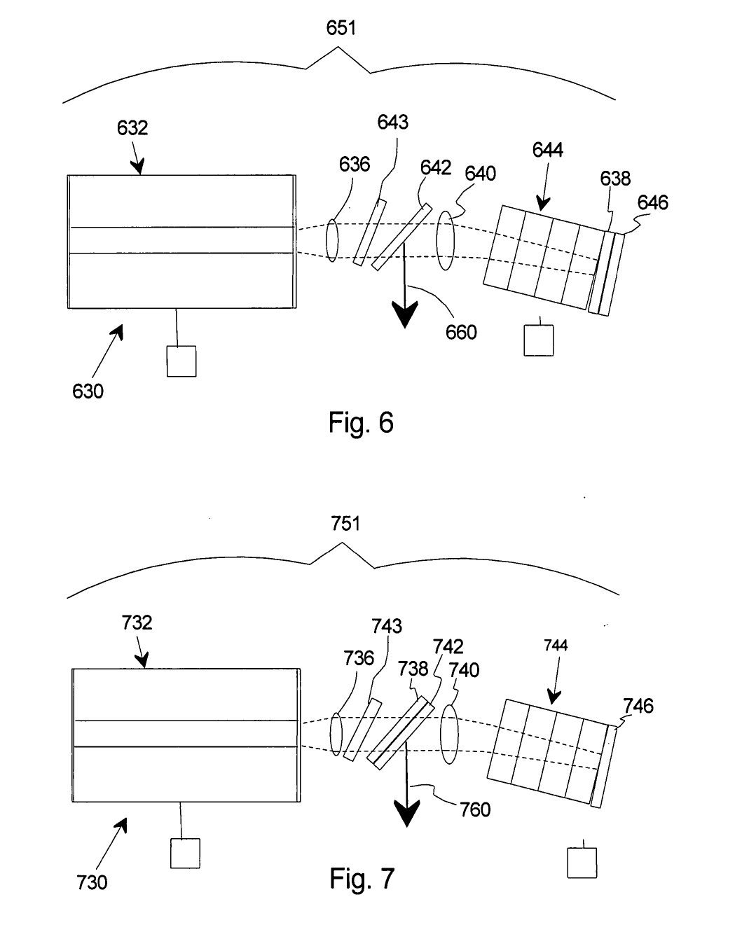

FIG. 5 illustrates another embodiment of a light source 530 that generates an output beam 560 that can be used in the apparatus 10 of FIG. 1. In this embodiment, the light source 530 includes a second optical assembly 536, a gain media 532, a wavelength controller 538, a third optical assembly 540, an intermediate reflector 542, a phase plate 543, a wavelength converter 544, and an output reflector 546 that are somewhat similar to the corresponding components described above and illustrated in FIG. 4. However, in this embodiment, the wavelength controller 538 is tilted, positioned adjacent to, and can be combined with the intermediate reflector 542. Further, the wavelength controller 538 and the intermediate reflector 542 can be coated simultaneously to reduce size, weight, cost, complexity, etc.

In the embodiment illustrated in FIG. 5, the wavelength controller 538 still controls center wavelength and number of modes, the wavelength converter 544 is positioned in the laser cavity 551 and the beam waist of the third optical assembly 540 is still located at or near the output coupler 546.

FIG. 6 illustrates another embodiment of a light source 630 that can be used to generate an output beam 660 in the apparatus 10 of FIG. 1. In this embodiment, the light source 630 includes a second optical assembly 636, a gain media 632, a wavelength controller 638, a third optical assembly 640, an intermediate reflector 642, a phase plate 643, a wavelength converter 644, and an output reflector 646 that are somewhat similar to the corresponding components described above and illustrated in FIG. 4. However, in this embodiment, the wavelength controller 638 and the output reflector 646 is tilted. Further, the wavelength controller 638 and the output reflector 646 are secured to the second side of the wavelength converter 644. As in the previous embodiment, the wavelength controller 638 and the output reflector 646 can be coated simultaneously.

Further, in FIG. 6, the output reflector 646 reflects all light (including visible and infrared). For example, the output reflector 646 can have a reflectance of at least approximately 95 percent. Thus, all light is retro-reflected back through the wavelength converter 644. Further, the intermediate reflector 642 is spaced apart from the wavelength converter 644 and the intermediate reflector 642 is tilted at a relatively large angle to separate and reflect all the doubled visible light out of the laser cavity (but without reflecting the IR light). In certain embodiments, the angle of the intermediate reflector 642 can be independently adjusted to precisely control the light. In FIG. 6, all visible light is directed transversely by the intermediate reflector 642 as the output beam 660, as the IR light passes back through the intermediate reflector 642 to the gain media 632.

In the embodiment illustrated in FIG. 6, the wavelength controller 638 still controls center wavelength and number of modes, the wavelength converter 644 is positioned in the laser cavity 651 and the beam waist of the third optical assembly 640 is still located at or near the output reflector 646.

FIG. 7 illustrates another embodiment of a light source 730 that can be used to generate a source output beam 760 in the apparatus 10 of FIG. 1. In this embodiment, the light source 730 includes a second optical assembly 736, a gain media 732, a wavelength controller 738, a third optical assembly 740, an intermediate reflector 742, a phase plate 743, a wavelength converter 744, and an output reflector 746 that are somewhat similar to the corresponding components described above and illustrated in FIG. 6.

However, in this embodiment, the wavelength controller 738 and the intermediate reflection 742 are combined to reduce size, weight, cost, complexity, etc., are tilted to reflect the visible light out of the cavity, and are spaced apart from the wavelength converter 744. Further, the output reflection 746 reflects light in both the visible and infrared range. Further, the output reflection 746 is secured to the wavelength converter 744 or coated directly onto converter 744 to reduce size, weight, cost, complexity, etc.

In FIG. 7, the IR light moving to the right is partially converted to visible light by the wavelength converter 744 and then reflects off the output reflector 746. The IR light that reflects off of the output reflector 746 goes to the left back through the wavelength converter 744 and is again partially converted to visible and then the visible is reflected by the intermediate reflector 742 so that it can then pass out of the cavity, shown here in the downward direction.

In the embodiment illustrated in FIG. 7, the wavelength controller 738 still controls center wavelength and number of modes, the wavelength converter 744 is positioned in the laser cavity 751 and the beam waist of the third optical assembly 740 is still located at or near the output reflector 746.

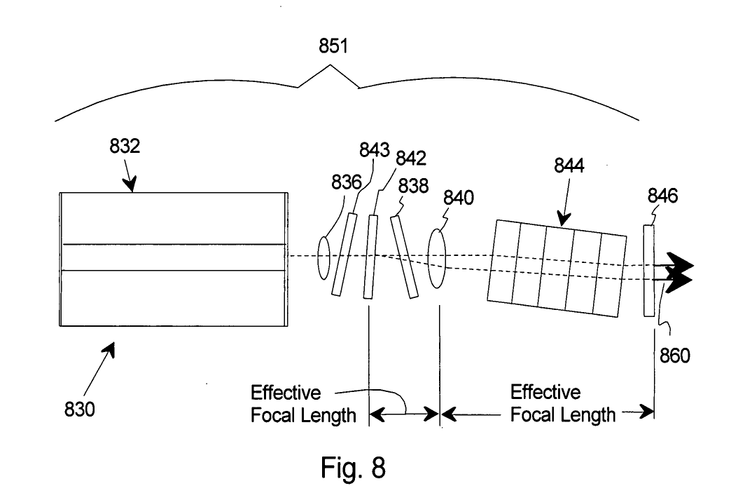

FIG. 8 illustrates another embodiment of a light source 830 that can be used to generate the source output beam 860 for use with the apparatus 10 of FIG. 1. In this embodiment, the light source 830 includes a second optical assembly 836, a gain media 832, a wavelength controller 838, a third optical assembly 840, an intermediate reflector 842, a phase plate 843, a wavelength converter 844, and an output reflector 846 that are somewhat similar to the corresponding components described above and illustrated in FIGS. 3-7.

However, in this embodiment, the intermediate reflector 842 is angled at approximately one degree, for example. Moreover, the wavelength controller 838 is angled at approximately one degree for example, and the back surface of the wavelength controller 838 is wedged to reduce interference effects. Further, in this embodiment, the wavelength converter 844 is rotated, approximately two degrees or less, for example.

In FIG. 8, the light that reflects off of the intermediate reflector 842 back to the wavelength converter 844 is displaced and at least partly off-set from the light that first passes through the wavelength converter 844. Stated in another fashion, the light that first travels through the wavelength converter 844 is offset from the light that is being reflected back into the wavelength converter 844 from the intermediate reflector 842. Thus, two spaced apart beams travel in substantially parallel paths through the wavelength converter 844. This reduces the influence of interference between the light that is traveling through the wavelength converter 844.

Further, because of the off-set light, two source output beams 860 (that may partly overlap) exit the output reflector 846. Because the intermediate reflector 842 is positioned at or near the effective focal length of the third optical assembly 840, the output beam from the light that is retro-reflected by the intermediate reflector 842 will exit the third optical assembly 840 and be parallel or nearly parallel to (and spaced apart from) the light that first travels through the wavelength converter 844. This improves the optical quality and ease of use of the visible output of the cavity.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A light source that generates a source output beam, the light source comprising:
a gain media having an output facet, the gain media generating a media output beam that exits the output facet, the media output beam having a first spectral frequency range and a relatively large number of modes;
an output reflector that is spaced apart from the gain media, the output reflector forming a portion of a laser cavity; and
a wavelength converter positioned within the laser cavity that converts at least a portion of the media output beam from the first spectral frequency range to a converted beam having at a secondary spectral frequency range that is different than the first spectral frequency range.

2. The light source of claim 1 wherein the second spectral frequency range is approximately two times greater than the first spectral frequency range.

3. The light source of claim 1 further comprising a wavelength controller positioned in the laser cavity that limits the number of modes that are lasing in the laser cavity.

4. The light source of claim 3 wherein the wavelength controller limits the number of modes that are lasing in the laser cavity to between approximately 10 and 100 modes.

5. The light source of claim 3 wherein the wavelength controller includes a thin-film filter.

6. The light source of claim 3 wherein the wavelength controller is positioned between the gain media and the wavelength converter.

7. The light source of claim 3 wherein the wavelength controller is positioned between the wavelength converter and the output reflector.

8. The light source of claim 1 wherein the output reflector reflects light in the infrared range and transmits light above the infrared range.

9. The light source of claim 1 wherein the output reflector reflects light in the infrared range and above the infrared range.

10. The light source of claim 1 further comprising an intermediate reflector positioned in the laser cavity between the gain media and the wavelength converter; wherein a portion of the media output beam is directed through the intermediate reflector into the wavelength converter and converted into the converted beam; wherein a portion of the beam is reflected off of the output reflector as a reflected beam; wherein the reflected beam is directed into the wavelength converter; wherein a portion of the reflected beam is transmitted through the intermediate reflector to the gain media; and wherein a portion of the reflected beam is reflected off of the intermediate reflector back to the wavelength converter.

11. The light source of claim 1 wherein the converted beam has a beam waist that is near the output reflector so that light reflected off of the output reflector is directed back into the wavelength converter.

12. A precision apparatus including an imager and the light source of claim 1 generating the source output beam that is transferred to the imager.

13. A light source that generates a source output beam, the light source comprising:
a gain media having an output facet, the gain media generating a media output beam that exits the output facet, the media output beam having a first spectral frequency range and a relatively large number of modes;
an output reflector that is spaced apart from the gain media, the output reflector forming a portion of a laser cavity;
a wavelength controller positioned in the laser cavity that limits the number of modes that are lasing in the laser cavity to between approximately 10 and 100 modes; and
a wavelength converter positioned within the laser cavity that converts at least a portion of the media output beam from the first spectral frequency range to a converted beam having at a secondary spectral frequency range that is different than the first spectral frequency range.

14. The light source of claim 13 wherein the wavelength controller limits the number of modes that are lasing in the laser cavity to between approximately 40 and 60 modes.

15. The light source of claim 13 wherein the output reflector reflects light in the infrared range back into the wavelength converter.

16. The light source of claim 13 further comprising an intermediate reflector positioned in the laser cavity between the gain media and the wavelength converter; wherein a portion of the media output beam is directed through the intermediate reflector into the wavelength converter and converted into the converted beam; wherein a portion of the beam is reflected off of the output reflector as a reflected beam; wherein the reflected beam is directed into the wavelength converter; wherein a portion of the reflected beam is transmitted through the intermediate reflector to the gain media; and wherein a portion of the reflected beam is reflected off of the intermediate reflector back to the wavelength converter.

17. The light source of claim 13 wherein the converted beam has a beam waist that is near the output reflector so that light reflected off of the output reflector is directed back into the wavelength converter.

18. A precision apparatus including an imager and the light source of claim 13 generating the source output beam that is transferred to the imager.

19. A method for generating a source output beam comprising the steps of:
generating a media output beam with a gain media, the media output beam having a first spectral frequency range and a relatively large number of modes;
reflecting light with an output reflector that is spaced apart from the gain media, the output reflector forming a portion of a laser cavity; and
converting at least a portion of the media output beam from the first spectral frequency range to a converted beam having at a secondary spectral frequency range with a wavelength converter that is positioned within the laser cavity.

20. The method of claim 19 further comprising the step of limiting the number of longitudinal modes that are lasing in the laser cavity to between approximately 10 and 100 modes with a wavelength controller positioned in the laser cavity.

21. The method of claim 19 further comprising the step of limiting the number of longitudinal modes that are lasing in the laser cavity to between approximately 40 and 60 modes with a wavelength controller positioned in the laser cavity.

22. The method of claim 19 wherein the step of reflecting light includes the step of reflecting light in the infrared range.

23. The method of claim 19 further comprising the step of positioning an intermediate reflector in the laser cavity between the gain media and the wavelength converter; wherein a portion of the media output beam is directed through the intermediate reflector into the wavelength converter and converted into the converted beam, wherein a portion of the converted beam is transmitted through the output reflector as an source output; wherein a portion of the beam is reflected off of the output reflector as a reflected beam; wherein the reflected beam is directed into the wavelength converter; wherein a portion of the reflected beam is transmitted through the intermediate reflector to the gain media; and wherein a portion of the reflected beam is reflected off of the intermediate reflector back to the wavelength converter.
